(19) United States
(12) Patent Application Publication
(10) Pub. No.: US 2020/0223404 A1
(43) Pub. Date: Jul. 16, 2020

(54) DRIVING SUPPORT SYSTEM

(71) Applicants: TOYOTA JIDOSHA KABUSHIKI KAISHA, Toyota-shi (JP); ADVICS CO., LTD., Kariya-shi (JP)

(72) Inventor: Masayuki ASANO, Kariya-shi (JP)

(73) Assignees: TOYOTA JIDOSHA KABUSHIKI KAISHA, Toyota-shi (JP); ADVICS CO., LTD., Kariya-shi (JP)

(21) Appl. No.: 16/679,510

(22) Filed: Nov. 11, 2019

(30) Foreign Application Priority Data
Jan. 11, 2019 (JP) 2019-003798

(51) Int. Cl. B60T 7/12

(52) U.S. Cl. CPC B60T 7/12; B60T 2250/04; B60T 2220/00; B60T 2201/06

(57) ABSTRACT

A driving support system installed on a vehicle includes a sensor detecting a vehicle state, a braking device, and a control device. The control device determines, based on the vehicle state, whether or not a first condition suggesting roll back of the vehicle is satisfied, and whether or not a second condition more strongly suggesting the roll back of the vehicle than the first condition is satisfied after the first condition is satisfied. When the second condition is satisfied after the first condition is satisfied, the control device executes roll back suppression control that controls the braking device to generate a braking force such that the vehicle stops. During a period from when the first condition is satisfied to when the second condition is satisfied, the control device executes precharge control that decreases play in the braking device without starting the roll back suppression control.

### BACKGROUND

### Technical Field

The present disclosure relates to a driving support system installed on a vehicle. In particular, the present disclosure relates to a driving support system for suppressing roll back of a vehicle.

### Background Art

There is a possibility that “roll back” occurs on a slope road and the like when a vehicle starts moving or immediately before the vehicle stops. The roll back is a vehicle movement that the vehicle moves in a direction opposite to a desired movement direction.

Patent Literature 1 discloses a technique intended to prevent roll back at a time when a vehicle starts moving. According to the technique, a detection means determines whether or not roll back occurs at a time when the vehicle starts moving. When the roll back is detected by the detection means, a friction brake control means generates a friction braking force in order to make the vehicle stop.

### LIST OF RELATED ART

Patent Literature 1: Japanese Unexamined Patent Application Publication No. JP-2015-202048

### SUMMARY

According to the technique disclosed in Patent Literature 1 described above, when it is determined that the roll back occurs, the braking force for stopping the vehicle is generated. However, noises and the like may cause erroneous determination that the roll back occurs. If such the erroneous determination is made, the braking force is unnecessarily generated even though there is no need to stop the vehicle. The unnecessary braking force hinders the vehicle travel and thus causes a user of the vehicle to feel a sense of strangeness.

An object of the present disclosure is to provide a technique that can appropriately suppress roll back of a vehicle without unnecessarily generating a braking force.

In a first aspect, a driving support system installed on a vehicle is provided.

The driving support system includes:

a sensor configured to detect a vehicle state being a state of the vehicle;

a braking device configured to generate a braking force; and

a control device configured to control the braking device.

The control device is further configured to:

determine, based on the vehicle state, whether or not a first condition suggesting roll back of the vehicle is satisfied;

determine, based on the vehicle state, whether or not a second condition more strongly suggesting the roll back of the vehicle than the first condition is satisfied after the first condition is satisfied;

when the second condition is satisfied after the first condition is satisfied, execute roll back suppression control that controls the braking device to generate the braking force such that the vehicle stops; and

during a period from when the first condition is satisfied to when the second condition is satisfied, execute precharge control that decreases play in the braking device without starting the roll back suppression control.

According to the first aspect, the driving support system determines whether or not the first condition suggesting the roll back is satisfied. When only the first condition is satisfied, the driving support system does not start the roll back suppression control. After the first condition is satisfied, the driving support system determines whether or not the second condition more strongly suggesting the roll back than the first condition is satisfied. When the second condition is satisfied after the first condition is satisfied, the driving support system executes the roll back suppression control so that the vehicle stops.

As a result, unnecessary roll back suppression control caused by the erroneous determination is suppressed. In other words, such a situation that the braking force is unnecessarily generated even though there is no need to stop the vehicle is prevented. Since the vehicle travel is prevented from being hindered by unnecessary braking force, a user of the vehicle is prevented from feeling a sense of strangeness.

Furthermore, during the period from when the first condition is satisfied to when the second condition is satisfied, the driving support system executes the precharge control that decreases play in the braking device without starting the roll back suppression control. The precharge control improves responsiveness of the braking device. Therefore, when starting the roll back suppression control in response to the second condition being satisfied, it is possible to quickly generate the braking force for stopping the vehicle. As a result, a roll back distance (i.e., a distance traveled by the vehicle due to the roll back) is shortened as compared with a case where the precharge control is not executed.

In this manner, it is possible to reduce the roll back distance without unnecessarily generating the braking force. That is, it is possible to appropriately suppress the roll back of the vehicle.

### BRIEF DESCRIPTION OF DRAWINGS

FIG. 1 is a conceptual diagram for explaining a driving support system according to an embodiment of the present disclosure;

FIG. 2 is a timing chart for explaining processing related to roll back suppression control according to the embodiment of the present disclosure;

FIG. 3 is a block diagram showing a configuration example of the driving support system according to the embodiment of the present disclosure;

FIG. 4 is a timing chart for explaining an example of roll back determination processing in the embodiment of the present disclosure;

FIG. 5 is a schematic diagram showing a configuration example of a braking device of the driving support system according to the embodiment of the present disclosure;

FIG. 6 is a flow chart showing a first example of the processing related to the roll back suppression control according to the embodiment of the present disclosure;

FIG. 7 is a flow chart showing a second example of the processing related to the roll back suppression control according to the embodiment of the present disclosure; and

FIG. 8 is a flow chart showing the second example of the processing related to the roll back suppression control according to the embodiment of the present disclosure.

### EMBODIMENTS

Embodiments of the present disclosure will be described below with reference to the attached drawings.

### 1. Outline

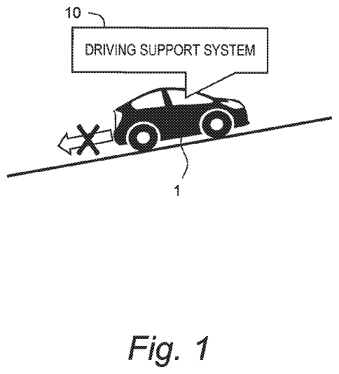

FIG. 1 is a conceptual diagram for explaining a driving support system 10 according to the present embodiment. The driving support system 10 is installed on a vehicle 1 and executes “driving support control” that supports driving of the vehicle 1.

As an example of the driving support control, “roll back suppression control” will be considered hereinafter. The roll back suppression control is vehicle control for suppressing roll back of the vehicle 1. The roll back is a vehicle movement that the vehicle 1 moves in a direction opposite to a desired movement direction. Typically, the roll back occurs on a slope road when the vehicle 1 starts moving or immediately before the vehicle 1 stops.

The driving support system 10 includes a sensor that detects a vehicle state being a state of the vehicle 1. Then, the driving support system 10 determines whether or not the roll back occurs (i.e., occurrence of the roll back) based on the vehicle state detected by the sensor. When it is determined that the roll back occurs, the driving support system 10 executes the roll back suppression control. More specifically, the driving support system 10 controls a braking device to generate a braking force such that the vehicle 1 stops.

However, noises input to the sensor and the like may cause erroneous determination that the roll back occurs. If such the erroneous determination is made, the braking force is unnecessarily generated even though there is no need to stop the vehicle 1. The unnecessary braking force hinders travel of the vehicle 1 and thus causes a user of the vehicle 1 to feel a sense of strangeness.

It is also conceivable to delay generation of the braking force in consideration of the erroneous determination of the roll back. However, in a case where the roll back actually occurs, a roll back distance (i.e., a distance traveled by the vehicle 1 due to the roll back) becomes long.

In view of the above, the present embodiment provides a technique that can appropriately suppress the roll back of the vehicle 1 without unnecessarily generating the braking force.

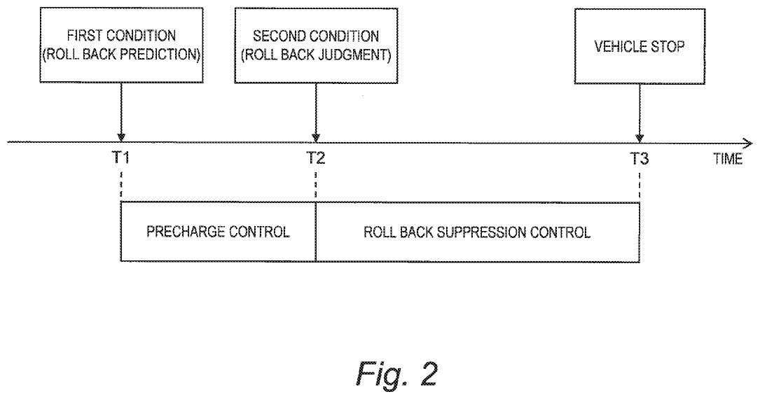

FIG. 2 is a timing chart for explaining processing related to the roll back suppression control according to the present embodiment. According to the present embodiment, whether or not the roll back occurs (i.e., occurrence of the roll back) is determined in two stages. For that purpose, two conditions, a “first condition” and a “second condition” are prepared for determining the occurrence of the roll back.

The first condition suggests (indicates) the roll back. The second condition more strongly suggests (indicates) the roll back than the first condition. Therefore, the second condition is less likely to be satisfied than the first condition, and is satisfied after the first condition is satisfied. In the example shown in FIG. 2, the first condition is satisfied at a time T1, and the second condition is satisfied at a time T2 after the time T1.

The driving support system 10 first determines whether or not the first condition is satisfied, based on the vehicle state detected by the sensor. It should be noted here that noises input to the sensor and the like may cause erroneous determination that the first condition is satisfied, as described above. Therefore, at the stage when only the first condition is satisfied, the driving support system 10 predicts occurrence of the roll back, but does not yet determine (judge) that the roll back occurs. The driving support system 10 does not yet start the roll back suppression control.

After the first condition is satisfied, the driving support system 10 determines whether or not the second condition is satisfied, based on the vehicle state detected by the sensor. When the second condition more strongly suggesting the roll back than the first condition is satisfied, possibility that the roll back occurs is extremely high. Therefore, when the second condition is satisfied after the first condition is satisfied, the driving support system 10 determines (judges) that the roll back occurs.

In response to the second condition being satisfied, the driving support system 10 starts the roll back suppression control. More specifically, the driving support system 10 controls a braking device to generate a braking force such that the vehicle 1 stops. As a result of the roll back suppression control, the vehicle 1 stops at a time T3.

Furthermore, according to the present embodiment, the driving support system 10 executes “precharge control” instead of the roll back suppression control during a period from when the first condition is satisfied to when the second condition is satisfied (i.e., a period from the time T1 to the time T2). The precharge control is such control that decreases “play” in the braking device before an effective braking force is generated.

As an example, a case of a hydraulic (oil-type) braking device is considered. In the precharge control, the driving support system 10 actuates a brake actuator to beforehand increase a pressure of a brake fluid supplied from the brake actuator to wheel cylinders. In a case of a disc brake, the driving support system 10 may actuate the brake actuator so that an ineffective stroke between a brake pad and a brake rotor is decreased.

The roll back suppression control is executed such that the vehicle 1 stops. While on the other hand, the precharge control is executed such that the vehicle 1 does not stop. Typically, the precharge control is executed such that no braking force is generated. As another example, the braking force may be generated to such an extent that a driver does not notice, that is, within a range in which the driver does not feel a sense of strangeness. In either case, a control amount of the braking device in the precharge control is smaller than the control amount of the braking device in the roll back suppression control.

Since such the precharge control is executed until the second condition is satisfied, responsiveness of the braking device is improved as compared with a case where the precharge control is not executed. Therefore, when starting the roll back suppression control in response to the second condition being satisfied, it is possible to quickly generate the braking force for stopping the vehicle 1. As a result, the roll back distance is shortened as compared with the case where the precharge control is not executed.

### Effects

According to the present embodiment, as described above, the driving support system 10 determines whether or not the first condition suggesting the roll back is satisfied. When only the first condition is satisfied, the driving support system 10 does not start the roll back suppression control. After the first condition is satisfied, the driving support system 10 determines whether or not the second condition more strongly suggesting the roll back than the first condition is satisfied. When the second condition is satisfied after the first condition is satisfied, the driving support system 10 executes the roll back suppression control so that the vehicle 1 stops.

As a result, unnecessary roll back suppression control caused by the erroneous determination is suppressed. In other words, such a situation that the braking force is unnecessarily generated even though there is no need to stop the vehicle 1 is prevented. Since the travel of the vehicle 1 is prevented from being hindered by unnecessary braking force, a user of the vehicle 1 is prevented from feeling a sense of strangeness.

Furthermore, according to the present embodiment, during the period from when the first condition is satisfied to when the second condition is satisfied, the driving support system 10 executes the precharge control that decreases the play in the braking device without starting the roll back suppression control. The precharge control improves the responsiveness of the braking device. Therefore, when starting the roll back suppression control in response to the second condition being satisfied, it is possible to quickly generate the braking force for stopping the vehicle 1. As a result, the roll back distance is shortened as compared with the case where the precharge control is not executed.

According to the present embodiment, as described above, it is possible to reduce the roll back distance without unnecessarily generating the braking force. That is, it is possible to appropriately suppress the roll back of the vehicle 1. This contributes to increase in confidence in the driving support system 10.

Hereinafter, the driving support system 10 according to the present embodiment will be described in more detail.

### 2. Example of Driving Support System

### 2-1. Configuration Example

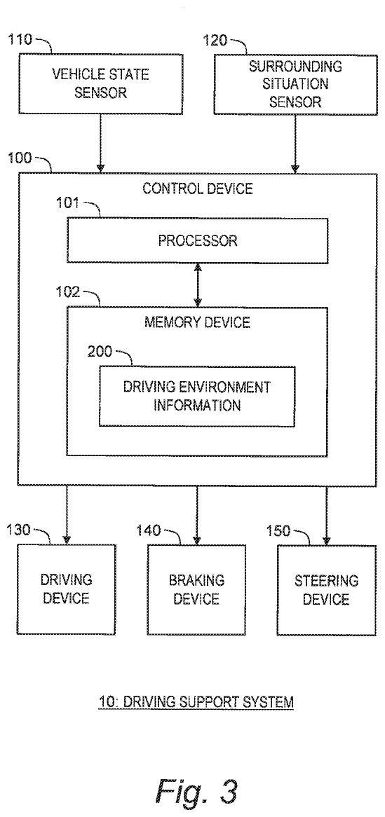

FIG. 3 is a block diagram showing a configuration example of the driving support system 10 according to the present embodiment. The driving support system 10 includes a control device (controller) 100, a vehicle state sensor 110, a surrounding situation sensor 120, a driving device 130, a braking device 140, and a steering device 150.

The control device 100 (controller) executes a variety of control processing with regard to the vehicle 1. Typically, the control device 100 is a microcomputer including a processor 101 and a memory device 102. The control device 100 is also called an ECU (Electronic Control Unit). The processing by the control device 100 is achieved by the processor 101 executing a control program stored in the memory device 102.

The vehicle state sensor 110 detects the vehicle state (i.e. a state of the vehicle 1). For example, the vehicle state sensor 110 includes a wheel speed sensor, a vehicle speed sensor, and a gear position sensor. The wheel speed sensor detects a speed of rotation and a direction of rotation of each wheel of the vehicle 1. The vehicle speed sensor detects a speed of the vehicle 1. The gear position sensor detects a gear state (shift state).

The vehicle state sensor 110 may include an inclination sensor and a GPS (Global Positioning System) sensor. The inclination sensor detects an inclination of a road surface on which the vehicle 1 is located. The GPS sensor detects a position and an orientation of the vehicle 1.

The vehicle state sensor 110 may include a driving operation sensor that detects a driving operation performed by a driver or the vehicle 1. The driving operation includes an acceleration operation, a braking operation, and a steering operation. The braking operation includes an operation of a brake pedal and an operation of a parking brake lever. The driving operation sensor includes an accelerator pedal sensor, a brake pedal sensor, a parking brake sensor, a steering angle sensor, a steering torque sensor, and the like.

The surrounding situation sensor 120 detects a situation around the vehicle 1. For example, the surrounding situation sensor 120 includes a camera, a LIDAR (Laser Imaging Detection and Ranging), and so forth. The camera images a situation around the vehicle 1. The LIDAR detects a target around the vehicle 1.

The driving device 130 generates a driving force. The driving device 130 is exemplified by an engine, an electric motor, and an in-wheel motor. The control device 100 generates a desired driving force by controlling an operation of the driving device 130.

The braking device 140 generates the braking force. The braking device 140 may be a hydraulic brake or may be a pneumatic brake. The braking device 140 may be a disc brake or a may be a drum brake. The control device 100 generates a desired braking force by controlling an operation of the braking device 140.

The braking device 140 further includes a parking brake. The driver can manually put the parking brake on by operating the parking brake lever. In addition, the control device 100 can automatically put the parking brake on.

The steering device 150 turns (i.e. change a direction of) the wheel of the vehicle 1. For example, the steering device 150 includes a power steering device (EPS: Electric Power Steering).

The control device 100 receives vehicle state information indicating the detected vehicle state from the vehicle state sensor 110. Moreover, the control device 100 receives surrounding situation information indicating the detected surrounding situation from the surrounding situation sensor 120. Driving environment information 200 includes the vehicle state information and the surrounding situation information. The driving environment information 200 is stored in the memory device 102.

The control device 100 executes the driving support control that supports driving of the vehicle 1 based on the driving environment information 200. The driving support control includes at least one of acceleration control, deceleration control, and steering control. The control device 100 can execute the acceleration control, the deceleration control, and the steering control by appropriately actuating the driving device 130, the braking device 140, and the steering device 150, respectively.

For example, the driving support control includes automated driving control and adaptive cruise control (ACC: Adaptive Cruise Control). The control device 100 automatically control travel of the vehicle 1 based on the driving environment information 200. For example, based on the surrounding situation information, the control device 100 recognizes a preceding vehicle as a target. Then, the control device 100 executes the acceleration control, the deceleration control, and the steering control as appropriate such that the vehicle 1 follows the preceding vehicle.

The driving support control further includes the roll back suppression control described above. Processing related to the roll back suppression control is as follows.

### 2-2. Roll Back Determination Processing

The control device 100 executes “roll back determination processing” that determines whether or not the roll back of the vehicle 1 occurs. In the roll back determination processing, the first condition and the second condition described above are used. The control device 100 determines whether or not each of the first condition and the second condition is satisfied, based on the vehicle state information obtained by the vehicle state sensor 110.

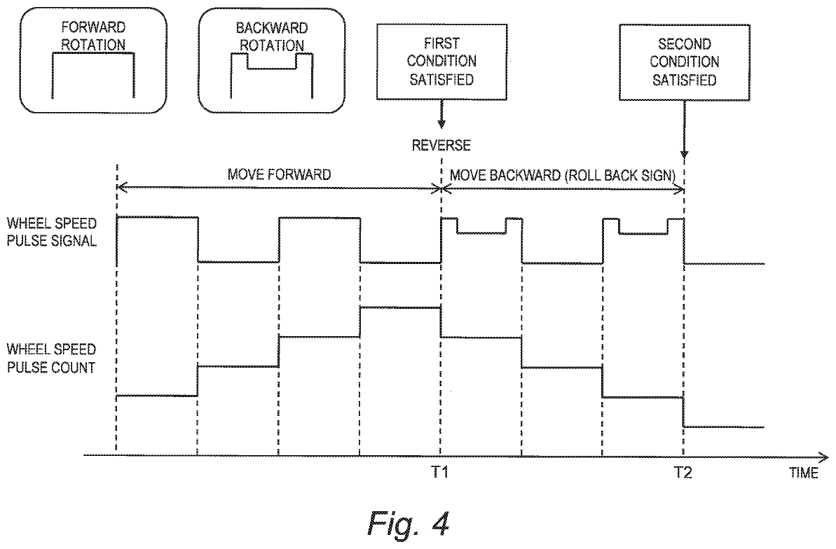

FIG. 4 is a timing chart for explaining an example of the roll back determination processing. In the example shown in FIG. 4, the direction of rotation of the wheel detected by the wheel speed sensor is used. A waveform of a wheel speed pulse signal differs depending on whether the wheel rotates forward or backward. It is therefore possible to recognize the direction of rotation of the wheel based on the waveform of the wheel speed pulse signal. A desired movement direction of the vehicle 1 is hereinafter referred to as a first direction. The first direction can be recognized based on the gear state (shift state) detected by the gear position sensor.

A case where the first direction is the forward direction is considered as an example. In the example shown in FIG. 4, the direction of rotation of the wheel is the forward direction until a time T1 and the backward direction after the time T1. That is, the direction of rotation of the wheel is the same as the first direction until the time T1, and is a second direction opposite to the first direction after the time T1. The first condition is that “the direction of rotation of the wheel is reversed from the first direction to the second direction”. The first condition is satisfied at the time T1. The second condition is that “a certain period of time passes with the direction of rotation of the wheel remaining in the second direction”. For example, the certain period of time is a period in which the wheel speed pulse signal is detected N time (N is an integer equal to or greater than 2). The second condition is satisfied at a time T2 after the time T1.

As another example, the vehicle speed may be used instead of the direction of rotation of the wheel. It is possible to determine whether the vehicle 1 moves forward or backward based on a sign (plus or minus) of the vehicle speed. As still another example, the position and the orientation of the vehicle 1 obtained by the GPS sensor may be used. It is possible to determine whether the vehicle 1 moves forward or backward based on a change in the position and the orientation of the vehicle 1.

As still another example, the first condition may be that “the vehicle 1 is located on a slope road”. The inclination of the road surface on which the vehicle 1 is located is detected by the inclination sensor. When the inclination of the road surface exceeds a predetermined value, it is determined that the vehicle 1 is located on a slope road. In this case, the second condition is, for example, that “the direction of rotation of the wheel is reversed from the first direction to the second direction”.

### 2-3. Precharge Control

During a period from when the first condition is satisfied to when the second condition is satisfied, the control device 100 executes the precharge control that decreases the “play” in the braking device 140 without starting the roll back suppression control.

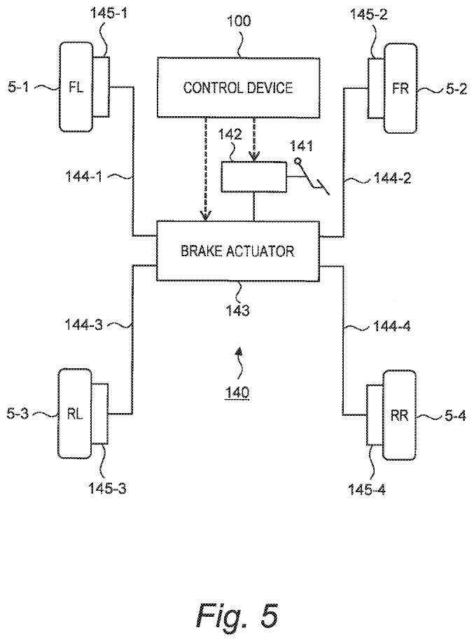

FIG. 5 is a schematic diagram showing a configuration example of the braking device 140. The braking device 140 includes a brake pedal 141, a master cylinder 142, a brake actuator 143, brake pipes 144-i (i=1 to 4), and wheel cylinders 145-i (i=1 to 4). The wheel cylinders 145-1, 145-2, 145-3, and 145-4 are provided for a left front wheel 5-1, a right front wheel 5-2, a left rear wheel 5-3, and a right rear wheel 5-4, respectively. The brake actuator 143 is connected to the wheel cylinder 145-i through the brake pipe 144-i.

The brake pedal 141 is an operating member used by the driver to perform the braking operation. The master cylinder 142 supplies a brake fluid having a pressure according to an operation amount of the brake pedal 141, to the brake actuator 143. The brake actuator 143 distributes the brake fluid to the wheel cylinder 145-i through the brake pipe 144-i. The brake actuator 143 includes valves and a pump, and can independently adjust the pressures of the brake fluids supplied to the wheel cylinders 145-i. The braking force generated at the wheel 5-i depends on the pressure of the brake fluid supplied to the wheel cylinder 145-i.

The control device 100 can control the master cylinder 142 and the brake actuator 143 independently of the operation of the brake pedal 141. The control device 100 can apply a desired braking force to the wheel 5-i by appropriately actuating the master cylinder 142 and the brake actuator 143. That is, the control device 100 can generate a desired braking force independently of the braking operation performed by the driver.

It should be noted that there is “play” before an effective braking force is generated at the wheel 5-i. For example, in a case of a disc brake, there is an ineffective stroke (i.e. a gap) between a brake pad and a brake rotor. The ineffective stroke corresponds to the play in the braking device 140. As another example, it takes some time for the brake actuator 143 to operate in response to a drive instruction from the control device 100. Furthermore, it takes some time from when the brake actuator 143 operates to when the pressure of the brake fluid in the wheel cylinder 145-i is increased sufficiently. These times also correspond to the play in the braking device 140.

In the precharge control, the control device 100 controls the brake actuator 143 such that the play in the braking device 140 is decreased. For example, the control device 100 beforehand actuates the brake actuator 143 such that at least a part of the above-described times is shortened. It is thus possible to increase in advance the pressure of the brake fluid supplied to the wheel cylinder 145-i. As another example, the control device 100 may actuate the brake actuator 143 such that the gap between the brake pad and the brake rotor is reduced.

Typically, the control device 100 executes the precharge control such that no braking force is generated. However, the braking force may be generated to such an extent that the driver does not notice, that is, within a range in which the driver does not feel a sense of strangeness. In either case, the control device 100 executes the precharge control such that the vehicle 1 does not stop.

### 2-4. Roll Back Suppression Control

When the second condition is satisfied after the first condition is satisfied, the control device 100 executes the roll back suppression control. More specifically, the control device 100 controls the braking device 140 to generate the braking force such that the vehicle 1 stops. A control amount of the braking device 140 in the roll back suppression control is greater than a control amount of the braking device 140 in the precharge control.

### 3. Process Flow

### 3-1. First Example

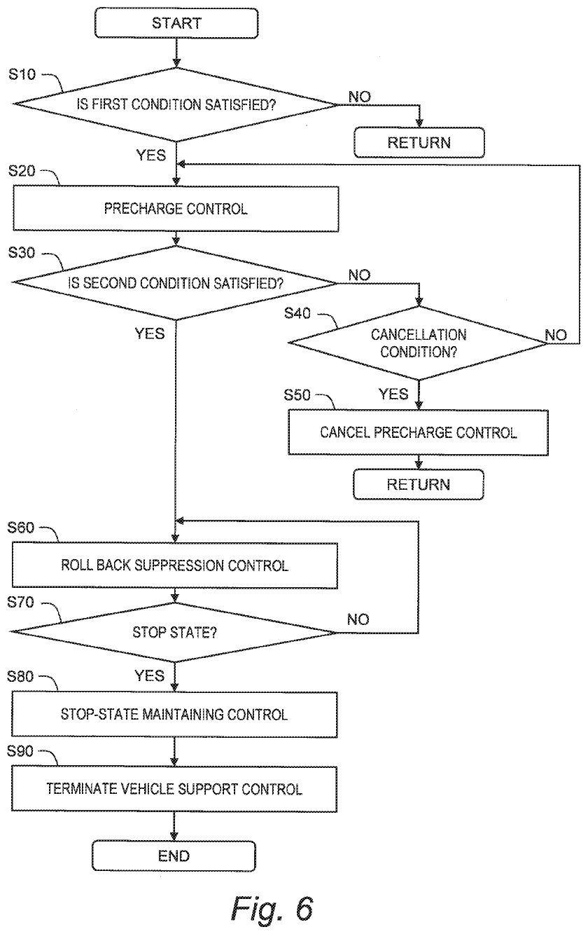

FIG. 6 is a flow chart showing a first example of the processing related to the roll back suppression control according to the present embodiment. It should be noted that at a start of the process flow shown in FIG. 6, the function of the driving support control is ON.

In Step S10, the control device 100 determines, based on the vehicle state information, whether or not the first condition suggesting the roll back of the vehicle 1 is satisfied. When the first condition is not satisfied (Step S10; No), the processing in the current cycle ends. When the first condition is satisfied (Step S10; Yes), the processing proceeds to Step S20.

In Step S20, the control device 100 executes the precharge control that decreases the play in the braking device 140.

In the subsequent Step S30, the control device 100 determines, based on the vehicle state information, whether or not the second condition is satisfied. The second condition more strongly suggests the roll back than the first condition. When the second condition is not satisfied (Step 30; No), the processing proceeds to Step S40.

In Step S40, the control device 100 determines whether or not a cancellation condition is satisfied. The cancellation condition indicates that a state after the first condition is satisfied is no longer maintained. For instance, in the example shown in FIG. 4, the first condition is that “the direction of rotation of the wheel is reversed from the first direction to the second direction”. The state after the first condition is satisfied is “a state in which the direction of rotation of the wheel is the second direction”. When the direction of rotation of the wheel is reversed again from the second direction to the first direction, the cancellation condition is satisfied.

When the cancellation condition is satisfied (Step S40; Yes), the control device 100 cancels the precharge control (Step S50). After that, the processing returns back to Step S10. On the other hand, when the cancellation condition is not satisfied (Step S40; No), the processing returns back to Step S20 and the control device 100 continues the precharge control.

When the second condition is satisfied (Step S30; Yes), the processing proceeds to Step S60. In Step S60, the control device 100 executes the roll back suppression control. More specifically, the control device 100 controls the braking device 140 to generate the braking force such that the vehicle 1 stops.

In Step S70, the control device 100 determines, based on the vehicle state information, whether or not the vehicle 1 is stopped. The vehicle speed is detected by the vehicle speed sensor. Alternatively, the vehicle speed may be calculated from the speed of rotation of each wheel detected by the wheel speed sensor. When the vehicle 1 is not yet stopped (Step S70; No), the processing returns back to Step S60 and the control device 100 continues the roll back suppression control. When the vehicle 1 is stopped (Step S70; Yes), the processing proceeds to Step S80.

In Step S80, the control device 100 executes stop-state maintaining control for maintaining the stop state of the vehicle 1. For example, the control device 100 automatically sets the gear state (shift state) to “P (Parking)”. As another example, the control device 100 may automatically put the parking brake on. As still another example, the control device 100 may execute brake hold control (i.e. maintaining the brake pressure of the wheel cylinder 145-i). The stop-state maintaining control may be a combination of some of the above examples.

In Step S90, the control device 100 terminates the driving support control.

### 3-2. Second Example

In a second example, the control device 100 selectively executes the precharge control depending on the situation.

For instance, a case where the control device 100 executes the automated driving control is considered. In this case, the user's sense of strangeness (discomfort) with respect to the roll back is particularly conspicuous. Therefore, it is desirable to execute the precharge control to shorten the roll back distance as much as possible.

On the other hand, in a situation where the driver performs manual driving, acceleration and deceleration of the vehicle 1 are under control of the driver. Moreover, even during the automatic driving control, when the driver intervenes in the acceleration and deceleration control, the acceleration and deceleration of the vehicle 1 are under control of the driver. When the acceleration and deceleration of the vehicle 1 are under control of the driver, the driver can suppress the roll back by himself or herself. Therefore, the driver's sense of strangeness with respect to the roll back is less likely to be produced. In such the situation, it is also conceivable to dare not execute the precharge control and to reduce loads applied on the control device 100 and the braking device 140.

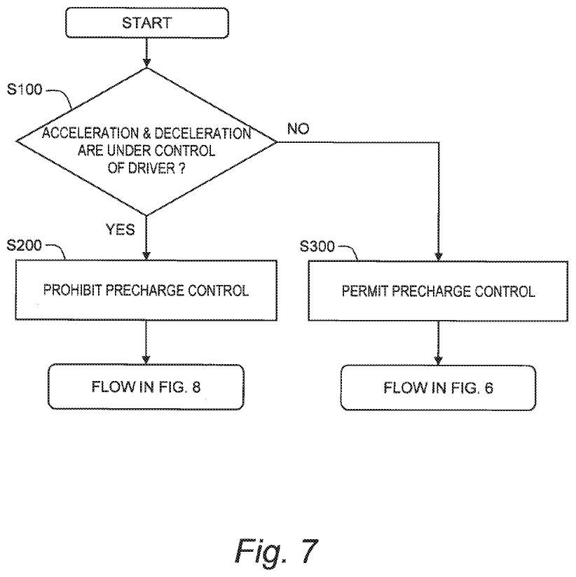

FIG. 7 shows an example in which the precharge control is selectively executed in view of the above. In the present example, the vehicle state information includes automated driving control information indicating a state (e.g. ON/OFF and level) of the automated driving control. In addition, the vehicle state information indicates the driving operation performed by the driver and detected by the driving operation sensor.

In Step S100, the control device 100 determines, based on the vehicle state information (specifically, the automated driving control information and the driving operation), whether or not the acceleration and deceleration of the vehicle 1 are under control of the driver. When the acceleration and deceleration of the vehicle 1 are under control of the driver (Step S100; Yes), the processing proceeds to Step S200. On the other hand, when the acceleration and deceleration of the vehicle 1 are not under control of the driver (Step S100; No), the processing proceeds to Step S300.

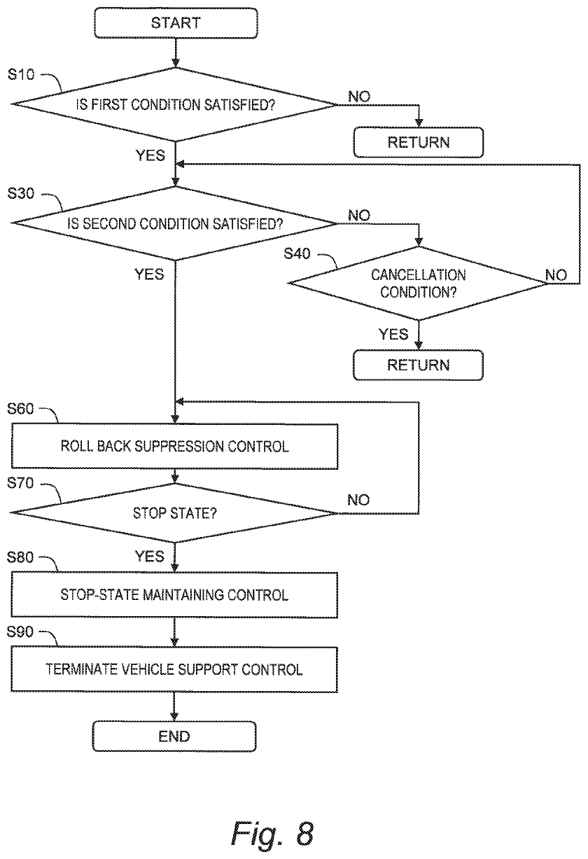

In Step S200, the control device 100 prohibits the precharge control. After that, a process flow shown in FIG. 8 is executed. In the process flow shown in FIG. 8, Step S20 (the precharge control) and Step S50 (cancellation of the precharge control) are omitted. Since the precharge control is not executed, the loads applied on the control device 100 and the braking device 140 are reduced. Moreover, since the driver can appropriately suppress the roll back by himself of herself, the driver's sense of strangeness with respect to the roll back is less likely to be produced.

In Step S300, on the other hand, the control device 100 permits the precharge control. After that, the process flow shown in FIG. 6 is executed. Since the precharge control is executed, the roll back distance is shortened. That is, the control device 100 appropriately suppresses the roll back of the vehicle 1. As a result, the user's sense of strangeness with respect to the roll back is suppressed.

What is claimed is:

1. A driving support system installed on a vehicle and comprising:
a sensor configured to detect a vehicle state being a state of the vehicle;
a braking device configured to generate a braking force; and
a control device configured to control the braking device, wherein
the control device is further configured to:
determine, based on the vehicle state, whether or not a first condition suggesting roll back of the vehicle is satisfied;
determine, based on the vehicle state, whether or not a second condition more strongly suggesting the roll back of the vehicle than the first condition is satisfied after the first condition is satisfied;
when the second condition is satisfied after the first condition is satisfied, execute roll back suppression control that controls the braking device to generate the braking force such that the vehicle stops; and
during a period from when the first condition is satisfied to when the second condition is satisfied, execute precharge control that decreases play in the braking device without starting the roll back suppression control.

2. The driving support system according to claim 1, wherein
the control device executes the precharge control such that the vehicle does not stop.

3. The driving support system according to claim 1, wherein
the control device executes the precharge control without generating the braking force.

4. The driving support system according to claim 1, wherein
when acceleration and deceleration of the vehicle are under control of a driver of the vehicle, the control device prohibits the precharge control, and
when the acceleration and deceleration of the vehicle are not under control of the driver, the control device permits the precharge control.
